(19) United States
(12) Patent Application Publication
(10) Pub. No.: US 2023/0007996 A1
(43) Pub. Date: Jan. 12, 2023

(54) Image Capturing Hardware and Methods

(71) Applicant: Mercedes-Benz Group AG, Stuttgart (DE)

(72) Inventors: Amit NENE, Menlo Park, CA (US); Naveen SANGENENI, Fremont, CA (US)

(21) Appl. No.: 17/782,420

(22) PCT Filed: Dec. 7, 2020
(86) PCT No.: PCT/US2020/063660

§ 371 Date: Jun. 3, 2022

Related U.S. Application Data
(60) Provisional application No. 62/944,831, filed on Dec. 6, 2019.

(51) Int. Cl. H04N 5/235; H04N 5/225

(52) U.S. Cl. CPC H04N 5/2352; H04N 5/2256; H04N 5/2258

(57) ABSTRACT

An image capturing system and methods of capturing images is provided. The system pairs an image sensor with a lighting element and light control components to improve image quality. The system further pairs one or more image sensor with one or more respective image focusing elements, thereby enabling the system to cover a variety of regions. Certain methods of the present invention include controlling light production and/or otherwise controlling when the sensor is exposed to light, what light the image sensor is exposed to, and which pathway the light must travel. By controlling light, the system and methods of the present invention controls image capture. Information availability is optimized and data processing is minimized by optimizing camera placement. Information reliability is optimized through routine assessment of the system and, when necessary, dynamically calibrating the system.

The present invention relates generally to image capturing devices and methods of utilizing the same. More specifically, the present invention is directed to systems for and methods of improving image quality and reliability of information associated with the same.

### BACKGROUND

Rolling shutter sensors are prone to image blur as the shutter exposes the sensor. If an object (such as a barcode on a package) is moving within the frame while the shutter is “rolling”, the object can be registered on the sensor multiple times at multiple locations, creating blur. By contrast, a global shutter sensor captures the entire frame instantaneously, eliminating the possibility that the object can be captured multiple times, thereby eliminating blur. While global shutter sensors have traditionally provided superior image quality when compared with rolling shutter sensors, global shutter sensors tend to be more expensive and have been known to require more processing power to operate. Accordingly, it would be beneficial to have a system for and a method of reducing blur when using a rolling shutter sensor.

To increase image quality captured by a rolling shutter and prove the theory, strobe lighting was used in a dark room environment. Specifically, the strobe lighting was timed to turn on at a specific time while the shutter is closing. Because the room is otherwise dark (0% lighting), the rolling shutter sensor is unable to capture an image until the strobe light is turned on (100% lighting), thereby reducing blur by reducing the number of times (and number of locations within a frame) an object can be captured during a shutter closing process. This absolute (0% to 100%) light differential associated with oscillating a dark room environment between dark (0% lighting) and light (100% lighting) produced a clear image with no blur.

While it is rarely practical to locate a camera system in a dark room environment, it has been found that image capture for a rolling shutter can be improved (blur can be reduced) by synchronizing light pulses of a strobe light with a light controlling component (i.e., a light gate). The improvement realized by adding the strobe light (rather than a constant light) is believed to be associated with the inability of certain light gates to block 100% of the ambient light when closed and/or the inability of the light gate to allow 100% of the ambient light to pass when open. For instance, certain liquid crystal shutters will block approx. 20% of available light when open and will only block approx. 90% of available light when closed. In other words, the light gate is unable to emulate absolute (0% to 100%) light differentials, but instead merely provide a variable (i.e., 20% to 90%) light differential. This variable light differential can be improved by synchronizing light pulses with the oscillation of the light gate from a closed configuration to an open configuration. As the variable light differential is improved - by incrementally increasing and decreasing the amount of light available - the image quality is improved. Unfortunately, strobe lighting creates possible health concerns and can be a distraction. Accordingly, it would be beneficial to have a system for and a method of eliminating or otherwise reducing health risks and distractions while still improving image quality.

For images capturing devices to be useful in the real world, they must be adaptable to a variety of environmental conditions. For instance, ambient light interferes with picture quality. Generally speaking, the more intense the ambient light is, the more the ambient light can adversely affect picture quality. While camera systems can be designed to accommodate a consistent lighting environment, variations in light, such as variations in an amount of light, an intensity of light, a spectrum of light, or the like, is difficult for systems of the prior art to overcome. Accordingly, it would be beneficial to have a system for and a method of minimizing adverse effects associated with adverse lighting conditions.

Due to various field-of-view and depth-of-view limitations, a single image capturing device is rarely sufficient to reliably capture an entire area without utilizing an autofocus mechanism. Unfortunately, existing autofocus technology is expensive and can be unreliable when exposed to extreme temperature changes and/or other environmental changes. Accordingly, it would be beneficial to have a system for and a method of optimizing a plurality of image capturing devices to focus on respective regions of the entire area, thereby facilitating complete capture of images associated with the same without requiring autofocus technology. Because image sensors can be expensive (and processing power is often limited to related components rather than the image sensors themselves), it would further be beneficial to include systems for and methods of utilizing a single image sensor with a plurality of lenses or the like, thereby facilitating the utilization of the single image sensor to capture images associated with a plurality of regions.

Every camera has a defined Field-of-View (FOV), which designates the area of coverage for the camera. This defines the viewing frustum that the camera can “see” and for which information (2D images, depth data, etc.) can be obtained. To obtain sufficient information regarding a three-dimensional space, multiple cameras are needed to cover the entire space; and the positioning of these cameras determines the number of cameras necessary to cover the specific space. Accordingly, it would be beneficial to have systems for and methods of optimizing camera locations, thereby minimizing the number of cameras necessary. However, attempting to do this manually may lead to an inefficient camera positioning and reduced area of coverage. Also, it is difficult to manually quantify overlap regions between two or more cameras looking at the same regions. Furthermore, attempting to minimize occlusion is also cumbersome owing to the abundance of unknown variables (presence of monuments, objects of different shapes and sizes, etc.). Due to the relatively high cost and somewhat tedious process of manually optimizing a multi-camera system, it would be beneficial to have a system for and a method of doing the same utilizing a virtual representation of a pertinent area. For the same reasons, it would further be beneficial to have a system for and a method of dynamically calibrating the same.

The information disclosed in this background of the disclosure section is only for enhancement of understanding of the general background of the invention and should not be taken as an acknowledgement or any form of suggestion that this information forms the prior art already known to a person skilled in the art.

### SUMMARY

The present invention comprises a system for and a method of capturing images in association with scanning and/or tracking objects.

In some embodiments, the present invention includes systems for and methods of reducing blur associated with using a rolling shutter sensor to capture images of fast-moving objects. The system includes an image capturing device (a “camera”) paired with a lighting element. The camera includes an image sensor having rolling shutter functionality and the light is configured to produce light pulses (“primary” pulses) at regular intervals, such as in a strobing effect, and/or the light is otherwise configured to turn on and off. In some embodiments, the light is connected to a pulse width modulator, thereby facilitating turning the light on and off. A light controlling component (a “shutter”) of the camera is synchronized with the primary pulses such that lighting differentials are maximized during an image capturing sequence. In this way, image quality is improved.

In some embodiments, the present invention includes systems for and methods of reducing health risks and distractions associated with generation of primary pulses at regular intervals. In particular, the lighting element (or another light source) is configured to produce additional light pulses (“auxiliary” pulses) that are synchronized with the primary pulses to eliminate discernable strobing effects while maintaining improved light differentials.

In some embodiments, the present invention includes systems for and methods of minimizing adverse effects associated with adverse lighting conditions. More specifically, certain embodiments of the present invention utilize filters, polarizers, and the like (“filters”) to absorb or reflect at least a portion of variable ambient lighting, thereby preventing such portion of the ambient lighting from adversely affecting image capture processes. In some embodiments, paired lighting is also used to assist with overcoming ambient lighting. In some embodiments, ambient lighting is measured to determine the anticipated effectiveness of the filters and/or the paired lighting. In some embodiments, post-processing of images is utilized to alleviate the effects of ambient lighting, such as when anticipated effectiveness of filters and/or paired lighting is determined to be unsatisfactory on its own.

In some embodiments, the present invention includes systems for and methods of optimizing a plurality of image capturing devices, each focused on respective regions of an entire area (such as the back of a van, storage areas, conveyor belts, or any other region for which the system can be utilized), thereby facilitating complete capture of images associated with the same. More specifically, certain embodiments of the present invention utilize first and second image sensors strategically positioned (variably or fixedly) relative to each other. Each sensor is paired with a respective first or second image focusing element that is focused on a respective first or second region. The first and second regions can be positioned adjacent to each other (such as directly above and below each other), can be displaced from each other, or can overlap with each other.

In some embodiments, the present invention includes systems for and methods of selectively pairing a single image sensor with more than one focusing element, thereby enabling a single image sensor to be utilized for capturing images in more than one region. In some embodiments, the present invention further includes a system for and methods of changing which region an image sensor is associated with, such as by incrementally and systematically changing pathways for which light must travel to reach the image sensor.

The foregoing and other objects are intended to be illustrative of the invention and are not meant in a limiting sense. Many possible embodiments of the invention may be made and will be readily evident upon a study of the following specification and accompanying drawings comprising a part thereof. Various features and subcombinations of invention may be employed without reference to other features and subcombinations. Other objects and advantages of this invention will become apparent from the following description taken in connection with the accompanying drawings, wherein is set forth by way of illustration and example, an embodiment of this invention and various features thereof.

### BRIEF DESCRIPTION

A preferred embodiment of the invention, illustrative of the best mode in which the applicant has contemplated applying the principles, is set forth in the following description and is shown in the drawings and is particularly and distinctly pointed out and set forth in the appended claims.

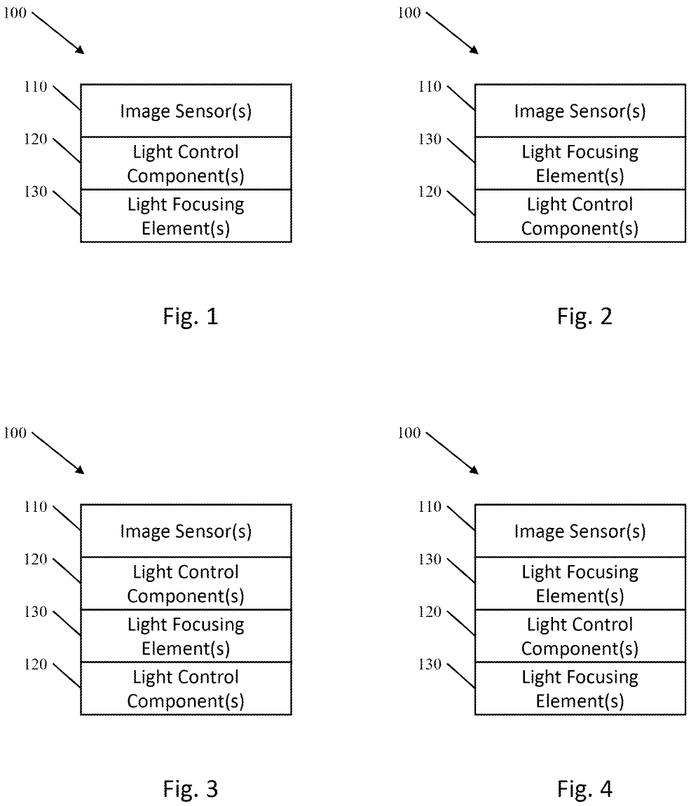

FIGS. 1-4 each show a schematic view of an embodiment of an image capturing device of the present invention.

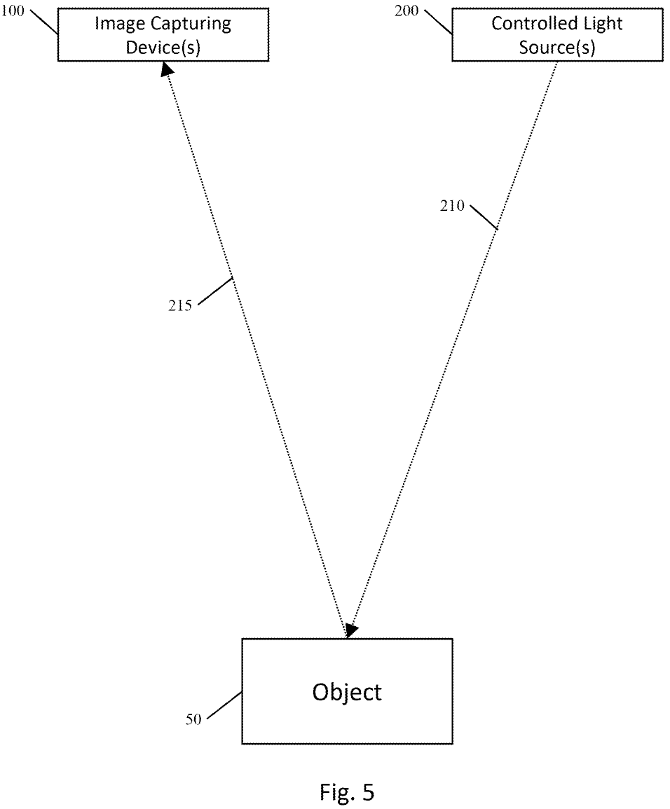

FIG. 5 is a schematic view of an imaging capturing device of the present invention paired with a controlled light source of the present invention.

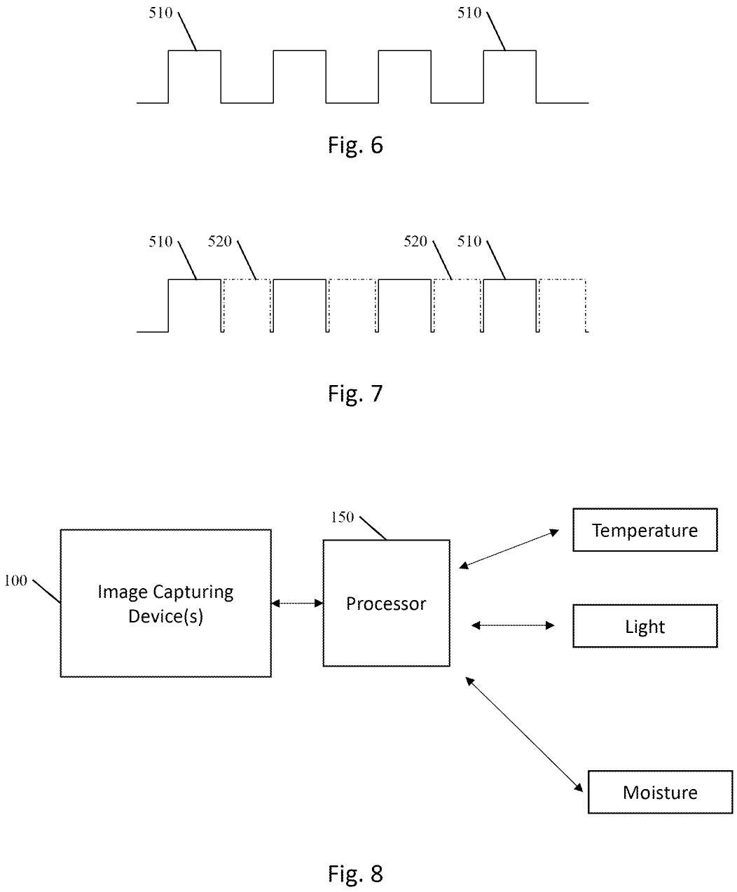

FIG. 6 is a schematic view showing primary pulses associated with an embodiment of the present invention.

FIG. 7 is a schematic view showing auxiliary pulses alternating with primary pulses in association with an embodiment of the present invention.

FIG. 8 is a schematic view of a processor of the present invention.

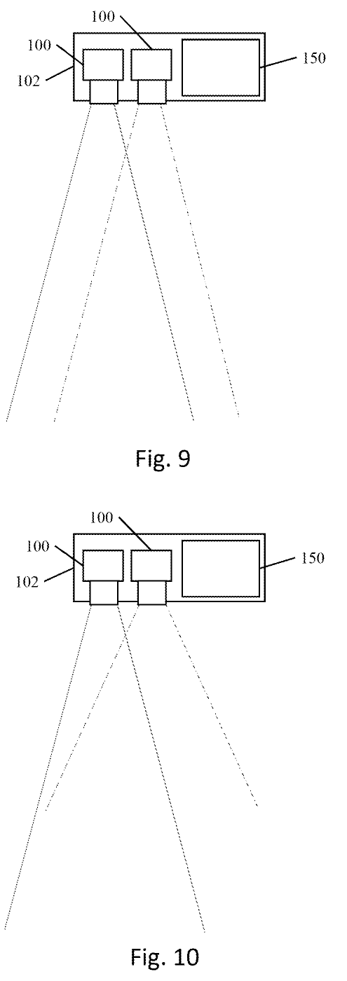

FIGS. 9-12 each show a different schematic view of a different camera module configuration associated with embodiments of the present invention.

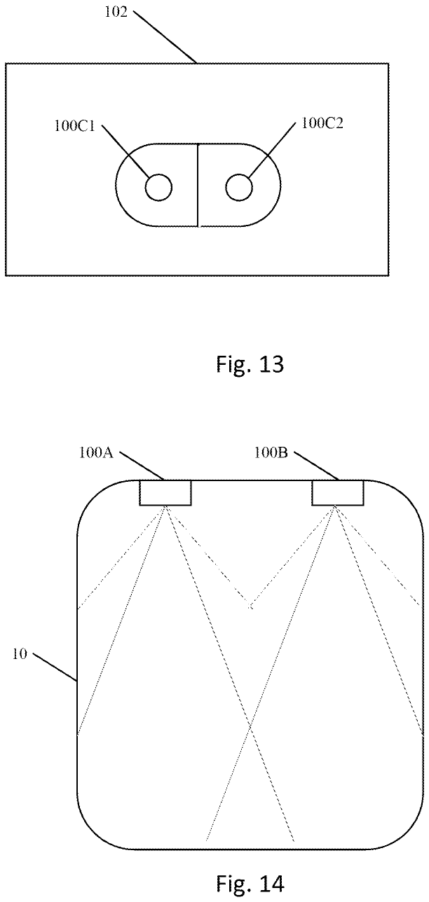

FIG. 13 is three-dimensional rendering of an embodiment of a camera module of the present invention.

FIG. 14 is a schematic view representing a scanning configuration associated with an embodiment of the present invention.

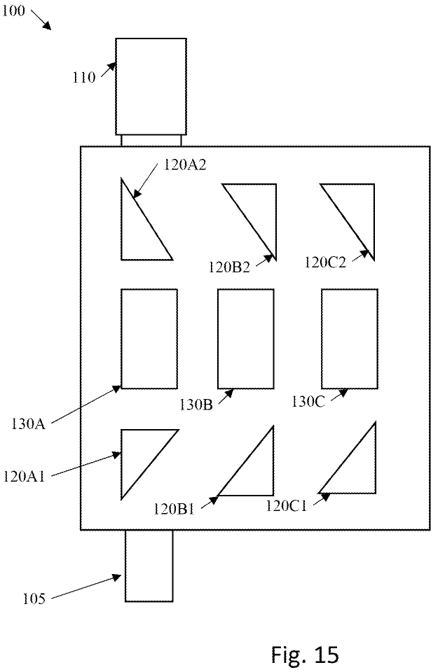

FIGS. 15-18 each show a schematic view of an embodiment of an image capturing device of the present invention.

### DETAILED DESCRIPTION

As required, a detailed embodiment of the present invention is disclosed herein; however, it is to be understood that the disclosed embodiment is merely exemplary of the principles of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

Referring to FIGS. 1-4, the present invention includes an image capturing device 100 comprising one or more image sensor 110 (such as a rolling shutter sensor, a global shutter sensor, or the like), one or more light controlling component 120 (such as a shutter, a filter, and/or the like), and one or more light focusing element 130 (such as a lens or the like). As shown in the various figures, and as described herein, certain embodiments of the present invention include various stack-ups and configurations of the same. It will be appreciated that certain features and methods of the present invention are further enabled by other configurations now known or later developed.

Referring to FIG. 5, some embodiments of the present invention further include one or more controlled light source 200, such as an LED light strip or the like. In some embodiments, the controlled light source(s) are configured to generate a first stream 210 of light directed at a first region relative the image capturing device, such as a first region along a conveyor belt, a first region of a rear doorway of a cargo van, or the like. In this way, the first stream 210 of light is configured to bounce off of an object 50 as it moves through the first region, thereby causing at least a first portion 215 of the first stream 210 of light to be reflected towards the image capturing device for use with an image capturing process associated with the same.

In some embodiments, the first stream 210 of light is configured to optimize or otherwise enable image capture of a barcode or other identifying means associated with the object 50 (each a “barcode”), such as by including at least some light waves that will not be absorbed by the barcode (some barcodes have been found to absorb infra-red light). In this way, the controlled light source is capable of generating and/or otherwise directing a first stream 210 of light having a first portion 215 for reflecting off of the barcode towards the image capturing device.

In some embodiments, the image sensor 110 utilizes rolling shutter functionality. In some such embodiments, the present invention utilizes one or more feature and/or method taught by DE102019000850.2; DE102018006765.4; and DE102018006764.6, the entire disclosures of which are incorporated herein by reference. In this way, the present invention is configured to reduce blur that is traditionally associated with use of rolling shutter sensors (where image capture “rolls” through subsequent columns of pixels over a short period of time, sometimes resulting in the same portion of a fast-moving object to be captured more than one time - causing what should be represented by a single pixel to be represented by more than one pixel - thereby generating blur) in certain applications, such as when capturing images of objects moving quickly through a region of focus associated with the image capturing device. In some such embodiments, the device of the present invention is capable of providing image quality similar to an image capturing device having a global shutter sensor (where all pixels of an image are captured at the same instant). In some embodiments, the image capturing device is configured to reduce blur when compared to other image capturing devices utilizing the same or comparable rolling shutter (or other) image sensors, such as by controlling light associated with the image sensor when capturing one or more image.

Referring to FIG. 6, and as taught by the Prior Applications, image quality associated with use of a rolling shutter sensor can be improved by synchronizing a light controlling component 120 with oscillation of a controlled light source 200 between an off configuration and an on configuration - thereby generating light pulses 510. In this way, light available to the image sensor during a first portion of each image capturing process (such as before a last image sensor line begins capture) can be eliminated or otherwise reduced while light available to the image sensor during a second portion of each image capturing process (such as after a last image sensor line begins capture but before a first image sensor line stops capturing) can be maximized or otherwise increased, thereby maximizing or otherwise increasing lighting differentials associated with respective first and second portions of each image capturing process.

### Auxilary Pulses

Referring to FIG. 7, some embodiments of the present invention include a means of generating an auxiliary light pulse 520 that is synchronized with the original (“primary”) pulse 510, thereby providing the appearance of a continuous (if frequency is greater than 60 Hz) or flickering (if frequency is less than 60 Hz) light. In this way, the present invention is capable of maintaining maximized lighting differentials while eliminating (or at least drastically reducing) concerns associated with a strobing light. In some embodiments, as represented by FIG. 7, the auxiliary pulses are timed relative to the primary pulses such that there is only a small period of time just before and just after each primary pulse during which the controlled light source is in an off configuration. In some embodiments, one or more control system synchronizes the auxiliary pulses with the primary pulses and/or with one or more other feature of the present invention, such as a light controlling component or the like. In some embodiments, an intensity of each auxiliary pulse is generally equal to an intensity of each primary pulse.

### Light Filter

Referring again to FIGS. 1-4, certain configurations of the present invention include a first class of light controlling components 120, such as the electronic and/or mechanical shutters disclosed in the Prior Applications (each a “shutter”). By synchronizing a shutter with a light controlling component, maximum light differential can be achieved, thereby improving image quality and/or reducing adverse effects associated with ambient lighting. In some embodiments, adverse effects associated with ambient lighting can be further reduced by use of a second class of light controlling components - such as light filters, light polarizers, and the like (each a “light filter”) - that are configured to block or otherwise hinder at least a portion of ambient light (sunlight, streetlights, and the like) from passing through the same to the image sensor, regardless of what configuration a shutter is in (i.e. open or closed configurations). In such embodiments, the controlled light source 200 produces at least a first portion 215 of a first stream 210 of light that is capable of passing through the light filter, thereby facilitating image capture using the same.

In some embodiments, at least part of a primary pulse of light includes properties that are configured to pass through one or more filter associated with the present invention. In some embodiments, at least part of an auxiliary pulse of light includes properties that are configured to be denied passage by one or more filter associated with the present invention.

In some embodiments, the system is configured to measure ambient lighting to determine anticipated effectiveness of a paired light configuration (light generated paired with light filters). In some embodiments, post-processing of one or more image is utilized to alleviate one or more issue associated with ambient lighting or otherwise. In some embodiments, one or more primary pulse is configured to provide light having a first set of properties, the properties being selected to maximize lighting effect associated with the same, such

### Measuring Conditions and Parameters

Referring to FIG. 8, some embodiments of the present invention include a processor 150 that is configured to measure surrounding conditions and/or object parameters associated with operation of one or more image capturing device 100. In some embodiments, information associated with the surrounding conditions include one or more of ambient lighting, temperature, moisture, humidity, and vibrations. In some embodiments, object parameters include speed of an object as it moves through a respective image capturing region, distance of the object from the camera, size of the object, and orientation of the object. In some embodiments, the object is a package or other object. In other embodiments, the object is a barcode (or the like) that is associated with a package or other object.

In some embodiments, the present invention is configured to create a sensor eco system associated with the surrounding conditions and/or the object parameters. In some such embodiments, one or more setting of the present invention are adjusted based on the sensor eco system. In some such embodiments, the one or more setting includes exposure time, brightness levels, shutter speeds, aperture sizes, lens focusing, and the like. In some embodiments, the ability to monitor and determine environmental conditions and/or specific use applications enables the system to be utilized in variable conditions and in a variety of circumstances.

### Depth of Field

Referring to FIGS. 9-12, some embodiments of the present invention include multiple image capturing devices 100 (C1, C2) positioned adjacent to each other, thereby enabling stereo photography and/or improving depth of field associated with the same. Referring to FIG. 13, some embodiments of the present invention include two image capturing devices (100C1, 100C2) positioned within, or otherwise associated with, a single mechanical enclosure 102. It will be understood that although multiple image capturing devices are contemplated by FIGS. 9-13, some embodiments, as contemplated herein, utilize a single image capturing device 100 having one or more image sensor 110. In some embodiments, each image capturing device of the first 100C1 and second 100C2 image capturing devices includes one or more feature for focusing on a respective region, such as respective first and second regions along a conveyor belt, first and second regions of a rear doorway of a cargo van, and the like. In some embodiments, the first region is positioned below the second region such that a first image focusing element associated with the first image capturing device is configured differently from a second image focusing element associated with the second image capturing device. In this way, the present invention is capable of effectively increasing the depth of field associated with the same. In some embodiments, the configurations of the first and second image focusing elements includes different aperture sizes, different focus points, different focal lengths, and/or the like. In some embodiments, one or more parameter of one or more image capturing device is adjustable, such as during a calibration and/or a focusing event. In some embodiments, one or more parameter of one or more image capturing device is fixed and/or is otherwise resistant to frequent or even occasional adjustment.

In some embodiments, respective depths of field (for purposes herein is associated with the respective regions within which a satisfactory image can be captured) overlap each other, are positioned adjacent to each other, and/or are spaced apart from each other. In one example, a pair of image capturing devices are positioned adjacent to each other at or near a back door of a van, the door having a height of approximately six and a half feet. In some embodiments of the present example, a first image capturing device of the pair of image capturing devices is focused on a first region extending from approximately the floor of the van to about half way to the ceiling of the van and a second image capturing device of the pair of image capturing devices is focused on a second region extending from approximately the ceiling of the van to about halfway to the floor of the van. In some embodiments, respective regions are determined based on anticipated location of objects and/or barcodes.

In some embodiments, the mechanical enclosure 102 is configured to maintain the first and second image capturing devices at a constant distance from each other, such as 28 mm. In other embodiments, the mechanical enclosure is configured to enable movement of the first and/or second image capturing device relative to the other, thereby facilitating adaptation of the system to satisfy one or more requirement and/or to overcome one or more environmental condition and/or mechanical parameter. In some embodiments, the system includes a motor, a pneumatic assembly, and/or one or more other mechanical means for adaptively adjusting location of one or more image capturing device. In some embodiments, a complete camera assembly along with a processor required for computation with the assembly required for the variable distance between the image capturing devices would be part of the same mechanical housing. In some embodiments, the mechanical housing has a fixed distance between the sensors.

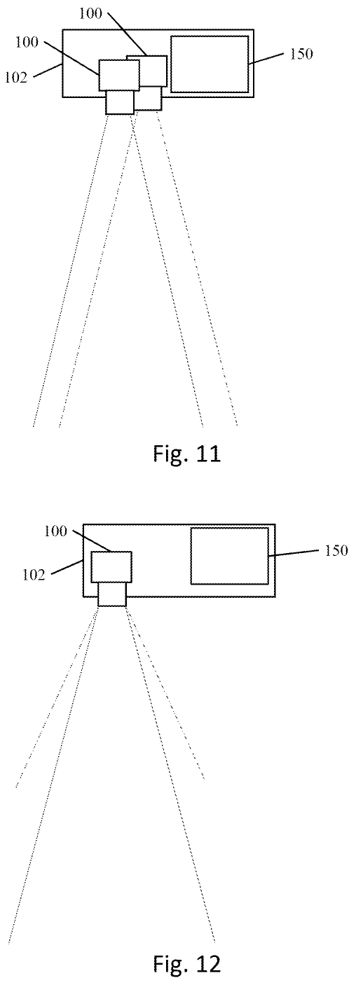

In some embodiments, an operating region of the image capturing devices can be managed by adjusting and/or maintaining aperture settings, focus point settings, lens type, or the like. In some embodiments the first and second image capturing devices utilize respective first and second types of lenses, each type of lens being different from the other. In some embodiments, depth data can be calculated using information associated with the distance between the two image capturing devices, information associated with each image capturing device being fed to the same processor. Referring again to FIGS. 9 and 10, some embodiments of the present invention utilize image capturing devices spaced apart along a first direction, such as laterally along a width of a van. Referring again to FIGS. 11 and 12, some embodiments of the present invention utilize image capturing devices spaced apart along a second direction, such as longitudinally along a length of a van.

### Field of View

Referring to FIG. 14, some embodiments of the present invention include one or more image capturing device (it will be understood that at least for the purpose of this portion of the disclosure, each image capturing device could include two or more image capturing devices) spaced along a monitored area, such as a monitored area comprising a plurality of regions, such as a first region, a second region, a third region, and the like. In one example, the monitored region is associated with a back door of a van 10 across which first 100A and second 100B image capturing devices are positioned. In this way, the first image capturing device 100A can be configured to focus on a first region (or in the event of multiple image capturing devices first and second regions or the like) and the second image capturing device 100B can be configured to focus on a second region (or in the event of multiple image capturing devices, third and fourth regions or the like). In this way, a complete region of operation can be covered, thereby eliminating blind spots, at least as they pertain to areas in which it is anticipated a package will be placed. In some embodiments, one or more blind spot is associated with a shelf or other object obscuring a view of one or more portion of one or more region. In some such embodiments, one or more additional image capturing device is utilized and/or adjusted to eliminate or reduce blind spots, if and as required or desired.

### Single Sensor Devices

Referring to FIGS. 15-18, certain embodiments of the present invention are configured to utilize a single image sensor with a plurality of lenses, thereby enabling expansion of a field of view and/or a depth of field with a single image sensor. It will be appreciated that the utilization of a single image sensor with a plurality of lenses presents an opportunity to reduce costs associated with rolling shutter sensors and/or global shutter sensors, thereby improving economic feasibility associated with obtaining the same.

Referring to FIG. 15, some embodiments include a view hole 105 through which all light required for image capture must pass. In some embodiments, the view hole 105 includes and/or is associated with a lighting control component, such as a shutter, a light filter, and/or the like. In some embodiments, the view hole 105 includes and/or is associated with a light focusing element, such as a lens or the like. In some embodiments, the view hole 105 is capable of functioning as a lighting control element and a light focusing element, thereby controlling and focusing light prior to such light passing into an interior area of the image capturing device 100.

Still referring to FIG. 15, some embodiments of the present invention include a plurality of light controlling components positioned between the view hole 105 and the image sensor 110, at least some such image controlling components being selectively moveable between a reflective configuration and a translucent configuration. In some embodiments, one or more light controlling components (and/or one or more component(s) thereof) is configured to move, such as by rotating, shifting, or the like, thereby moving the light controlling component between reflective and translucent configurations. In some embodiments, moving the light controlling component between a reflective configuration and a translucent configuration by changing one or more characteristic of the light controlling component (and/or one or more component thereof), such as by providing (or denying) electrical current to an associated electronic shutter, thereby causing the electronic shutter to be in an opaque (or translucent) configuration. In this way, the plurality of light controlling components are capable of routing the light through one of a plurality of lenses (130A, 130B, 130C, etc.), each lens being configured to satisfy a respective purpose.

In one example, a first light controlling component 120A1 of a first pathway is moved to a translucent configuration, thereby allowing light to pass through a first lens 130A and towards the image sensor 110. In some such embodiments, the light must first travel through a second light controlling component 120A2 along the first pathway. It will be appreciated that in some embodiments, each light controlling component along a designated pathway is not entirely reflective and/or entirely translucent such that not all of the light passes along the respective pathway in every situation. It will be further understood that in such situations, a majority of the light associated with image capture passes along the respective pathway, thereby enabling image capture associated with the same.

In another example, a first light controlling component 120A1 along a first pathway is moved to a reflective configuration, thereby causing light to be reflected towards a first light controlling component 120B1 of a second pathway. It will be understood that the configuration of the first light controlling component 120B1 of the second pathway dictates whether the light (or at least a majority thereof) is reflected along the second pathway towards a second lens 130B or whether it passes through the same towards a first light controlling component 120C1 of a third pathway. It will be further understood that the third path, as shown in FIG. 15, includes a third lens 130C, and the second and third pathways include respective second (120B2, 120C2) light controlling components. It will be appreciated that the three-pathway configuration shown is provided as an example only and that the present invention can be practiced with two pathways and/or with more than three pathways.

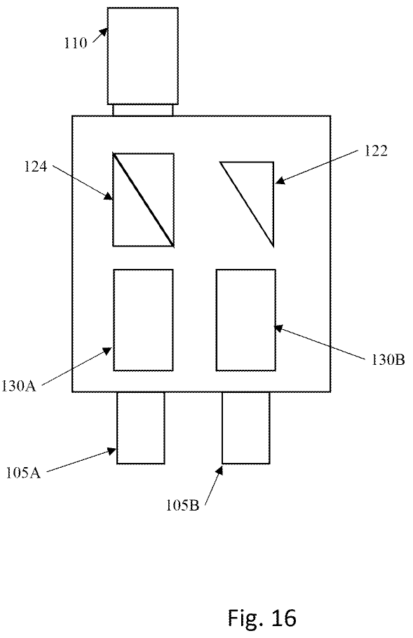

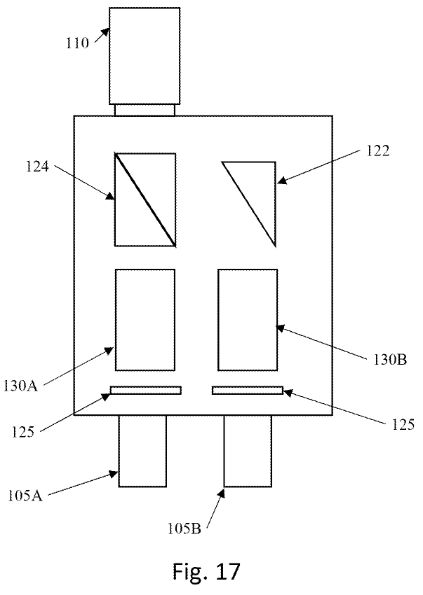

Referring to FIGS. 16 and 17, some embodiments of the present invention include a plurality of view holes, such as first 105A and second 105B view holes, each view hole 105 being associated with a respective first or second pathway. In such embodiments, a plurality of light controlling elements are configured to selectively block light (or at least a majority of light) associated with one or more of the first and second pathways, thereby controlling image capture associated with the same. It will be appreciated that the two-pathway configurations shown are provided as examples only and that the present invention can be practiced with more than two pathways. Some embodiments include a mirror with reflective coating 122 and/or one or more variable optic feature 124, such as a feature formed from an optic material and having an actuator or electronic opacity control associated with selectively reflecting light or allowing light to pass through. In some embodiments a shutter 125 is positioned between a lens and a view hole 105. Though not depicted in the figures, it will be appreciated that shutter 125 may otherwise be arranged between a lens 130 and sensor 110, between an object and lens 130, or in any other configuration to result in the desired image capture.

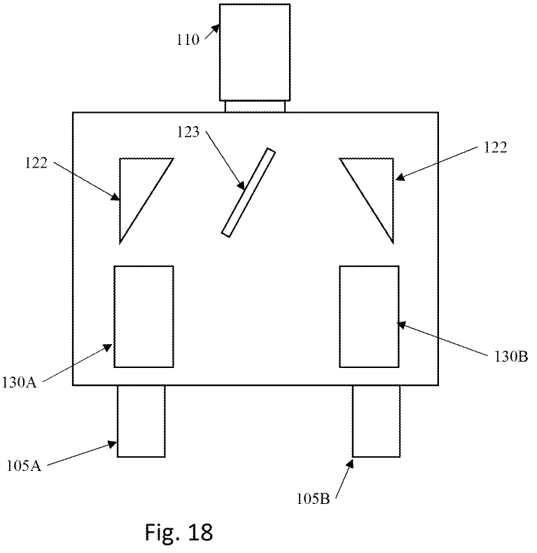

Referring to FIG. 18, some embodiments of the present invention include a rotating reflective surface 123 (or other light controlling component now known or later developed that is capable of performing the same or similar function, each being referred to herein as a rotating reflective surface) positioned between first and second pathways of the present invention. In some embodiments, the rotating reflective surface is configured to selectively complete a first pathway while blocking the second pathway (or vice versa) by allowing light (or at least a majority of light) associated with the first pathway to be reflected towards an image sensor while preventing light from the second pathway from doing the same. It will be appreciated that the two-pathway configuration shown is provided as an example only and that the present invention can be practiced with more than two pathways. It will further be appreciated that the current configuration can be practiced in a single pathway configuration, thereby eliminating or otherwise reducing the need to pulsate a lighting source.

In the foregoing description, certain terms have been used for brevity, clearness and understanding; but no unnecessary limitations are to be implied therefrom beyond the requirements of the prior art, because such terms are used for descriptive purposes and are intended to be broadly construed. Moreover, the description and illustration of the inventions is by way of example, and the scope of the inventions is not limited to the exact details shown or described.

Although the foregoing detailed description of the present invention has been described by reference to an exemplary embodiment, and the best mode contemplated for carrying out the present invention has been shown and described, it will be understood that certain changes, modification or variations may be made in embodying the above invention, and in the construction thereof, other than those specifically set forth herein, may be achieved by those skilled in the art without departing from the spirit and scope of the invention, and that such changes, modification or variations are to be considered as being within the overall scope of the present invention. Therefore, it is contemplated to cover the present invention and any and all changes, modifications, variations, or equivalents that fall within the true spirit and scope of the underlying principles disclosed and claimed herein. Consequently, the scope of the present invention is intended to be limited only by the attached claims, all matter contained in the above description and shown in the accompanying drawings shall be interpreted as illustrative and not in a limiting sense.

Having now described the features, discoveries and principles of the invention, the manner in which the invention is constructed and used, the characteristics of the construction, and advantageous, new and useful results obtained; the new and useful structures, devices, elements, arrangements, parts and combinations, are set forth in the appended claims.

It is also to be understood that the following claims are intended to cover all of the generic and specific features of the invention herein described, and all statements of the scope of the invention which, as a matter of language, might be said to fall therebetween.

What is claimed is:

1. An imaging system comprising:
a first image sensor;
a first light controlling component for controlling light exposure of the first image sensor; and
a first light source for producing primary pulses of light,
wherein the first light controlling component is synchronized with the first light source such that light exposure prior to each primary pulse of light is minimized and light exposure during each primary pulse of light is maximized, and
wherein the imaging system generates auxiliary light, the auxiliary light being configured to minimize discernable strobing effects of the primary pulses of light.

2. The imaging system of claim 1, wherein the auxiliary light is produced by the first light source.

3. The imaging system of claim 2, wherein the auxiliary light comprises auxiliary pulses of light that are synchronized with the primary pulses of light.

4. The imaging system of claim 1, wherein the auxiliary light consists of auxiliary pulses of light that are synchronized with the primary pulses of light.

5. The imaging system of claim 4, wherein the first light controlling component is a liquid crystal shutter.

6. The imaging system of claim 1, further comprising a second light controlling component for reducing exposure of the first image sensor to ambient lighting, the second light controlling component being one of a light filter and a light polarizer.

7. The imaging system of claim 6, wherein at least a portion of each primary pulse of light is configured to pass through the second light controlling component to the first image sensor.

8. The imaging system of claim 7, wherein the second light controlling component is configured to inhibit passage of at least a portion of the auxiliary light.

9. The imaging system of claim 1, further comprising a second image sensor positioned adjacent to the first image sensor, each of the first and second image sensors being associated with respective first and second lenses having respective first and second parameters.

10. The imaging system of claim 1, further comprising a lens assembly associated with the first image sensor, the lens assembly comprising first and second lenses and defining respective first and second pathways, wherein the first and second lenses have respective first and second parameters, wherein a first configuration of the lens assembly facilitates passage of light through the first pathway to the first image sensor while inhibiting passage of light through the second pathway, and wherein a second configuration of the lens assembly facilitates passage of light through the second pathway to the first image sensor while inhibiting passage of light through the first pathway.

11. An imaging system comprising:
a first image sensor;
a first light controlling component for controlling light exposure of the first image sensor; and
a first light source for producing primary pulses of light,
wherein the imaging system generates auxiliary light, the auxiliary light being configured to minimize discernable strobing effects of the primary pulses of light, and
wherein the first light controlling component is configured to inhibit passage of at least a portion of the auxiliary light.

12. The imaging system of claim 11, wherein the auxiliary light is produced by the first light source.

13. The imaging system of claim 12, wherein the light controlling component is one of a light filter and a light polarizer.

14. The imaging system of claim 11, further comprising a second image sensor positioned adjacent to the first image sensor, each of the first and second image sensors being associated with respective first and second lenses having respective first and second parameters.

15. The imaging system of claim 11, further comprising a lens assembly associated with the first image sensor, the lens assembly comprising first and second lenses and defining respective first and second pathways, wherein the first and second lenses have respective first and second parameters, wherein a first configuration of the lens assembly facilitates passage of light through the first pathway to the first image sensor while inhibiting passage of light through the second pathway, and wherein a second configuration of the lens assembly facilitates passage of light through the second pathway to the first image sensor while inhibiting passage of light through the first pathway.

16. An imaging system comprising:
an image sensor;
a first light source for producing primary light; and
a lens assembly associated with the image sensor, the lens assembly comprising a first lens and defining a first pathway,
wherein a first configuration of the lens assembly facilitates passage of light through the first pathway to the image sensor, and
wherein a second configuration of the lens assembly inhibits passage of light through the first pathway.

17. The imaging system of claim 16, wherein the lens assembly further comprises a second lens and further defines a second pathway, wherein the first and second lenses have respective first and second parameters, wherein the first configuration of the lens assembly inhibits passage of light through the second pathway, and wherein the second configuration of the lens assembly facilitates passage of light through the second pathway to the image sensor.

18. The imaging system of claim 16, wherein the primary light comprises primary pulses of light that are synchronized with movement of the lens assembly to the first configuration.

19. The imaging system of claim 18, wherein the imaging system generates auxiliary light, the auxiliary light being configured to minimize discernable strobing effects of the primary pulses of light.

20. The imaging system of claim 19, wherein the auxiliary light comprises auxiliary pulses of light that are synchronized with the primary pulses of light.
